(19) United States
(12) Patent Application Publication
(10) Pub. No.: US 2026/0236900 A1
(43) Pub. Date: Aug. 13, 2026

(54) Computer-implemented method and system for implementing real-time royalty and enforcing real-time royalty payments in a blockchain network

(71) Applicants: Joshua Combs, Dayton, OH (US); Christopher W. Hill, Dayton, OH (US)

(72) Inventors: Joshua Combs, Dayton, OH (US); Christopher W. Hill, Dayton, OH (US)

(21) Appl. No.: 19/082,299

(22) Filed: Mar. 18, 2025

Related U.S. Application Data
(60) Provisional application No. 63/755,355, filed on Feb. 7, 2025.

(51) Int. Cl. G06Q 20/10; G06Q 20/06; G06Q 20/12; G06Q 20/36; G06Q 20/38

(52) U.S. Cl. CPC G06Q 20/102; G06Q 20/06; G06Q 20/1235; G06Q 20/36; G06Q 20/382

(57) ABSTRACT

A computer-implemented method and system for implementing real-time royalty and enforcing real-time royalty payments in a blockchain network which includes providing a portal platform for rights owner onboarding and registration data and providing a crypto wallet for smart contract credit, debit and staking transactions, a module for uploading user proprietary content data and metadata corresponding to the proprietary content data; a decentralized storage system for the data; employing an AI module for detecting a transaction use of the proprietary content data and using a smart contract stored on a blockchain, wherein the transaction used is associated with a verified digital asset and transaction using the asset; employing an AI module for automatically computing a royalty based on a predefined percentage stored in the smart contract; executing a transfer using a cryptographically secure digital transaction; and recording the completed transaction on the blockchain to create an immutable ledger entry.

### FIELD OF INVENTION

The instant invention relates to the field of computer implemented royalty payments. More particularly, the invention relates to a blockchain-powered system and method for real-time royalty distribution for music, podcasts, and digital content that calculates a monetized stream.

### BACKGROUND OF INVENTION

In the context of some intellectual property owners, e.g, artists, i.e., traditional music and digital content royalty distribution systems involve multiple intermediaries, including record labels, aggregators, and streaming platforms. This leads to delays in payments, reduced transparency, and significant revenue losses for artists due to high administrative fees and profit-sharing arrangements. Existing models also lack the ability to automatically detect and recover unclaimed royalties or provide real-time payout capabilities. Further, the current systems are easily subject to fraudulent transactions. There is a critical need for a system that streamlines these processes, offering immediate payments, transparent transactions recorded on a blockchain, and automated rights management through AI.

Currently, BMI, ASCAP, and SESAC are performance rights organizations (PROs) that collect and distribute royalties for songwriters, composers, and publishers. PROs track performances of registered songs across various platforms and sources, including: Radio and TV: AM/FM, satellite, and streaming radio stations (e.g., Pandora); Live Venues: Concerts, bars, restaurants, and nightclubs that play music publicly; Streaming Services: Platforms like Spotify, Apple Music, and YouTube; Retail and Businesses: Background music in stores, hotels, gyms, etc.

These businesses pay licensing fees to the PROs, which then pool the money into a general royalty fund.

Each PRO uses a different formula to determine payments, factoring in how often and where a song is played. They track performances through logs, digital monitoring, and self-reporting by artists.

The royalties are split between songwriters (e/g 30%) and publishers and processors (70%). Payments are made quarterly (ASCAP and BMI) or monthly (SESAC).

Songwriters and publishers must register their songs with a PRO. Each PRO operates separately, so songwriters must choose one (BMI, ASCAP, or SESAC). Publishers can register with multiple PROs if they represent different songwriters.

### Key Differences Between BMI, ASCAP, and SESAC

ASCAP: Nonprofit, requires a one-time membership fee.

BMI: Nonprofit, free for songwriters but has a publisher fee.

SESAC: For-profit, invitation-only, and pays monthly instead of quarterly.

Maximizing royalties through BMI, ASCAP, or SESAC involves a combination of proper song registration, performance tracking, and strategic placement of your music. Here's how you can ensure you're earning as much as possible:

Every song must be registered and if a song isn't in the PRO's database, you won't get paid. Registration data includes
Song title
Co-writers (if applicable)
Publisher (if you have one)
ISWC (International Standard Work Code)

Split Percentages Correctly—If you co-write with others, ensure your PRO reflects the correct royalty splits (e.g., 50/50 or 33/33/33). If you perform your own music live, most PROs allow you to self-report those performances for royalties, ASCAP's OnStage, BMI's Live, SESAC's live reporting system, for example.

Radio and TV Play monitoring services like Mediabase and BDS (Broadcast Data Systems) to see if your songs are getting played. If they are and you're not seeing royalties, you must contact your PRO. PROs have agreements with international organizations, but these take longer to process. Royalties generated overseas are only collected by ASCAP, BMI or PRO's with agreements with foreign PRO's. Most of these aforementioned ways that overseas royalties are collected require a third-party resource such as song trust. This system utilizes AI and blockchain analysis to track these overseas royalties and collect them. If you have overseas plays, it requires checking Songview (ASCAP/BMI) or SESAC's system.

Maximize streaming and sync royalties is attempted by registering with SoundExchange. PROs collect performance royalties, but SoundExchange collects digital performance royalties for non-interactive streams (Pandora, SiriusXM, etc.). This is a separate income stream.

Sync Placements. PROs pay royalties when your music is used in TV, film, ads, and video games. Working with a sync licensing agency or register with libraries like Musicbed, Artlist, or AudioJungle can be used to land placements.

Publishing Admin like Songtrust, TuneCore Publishing, or CD Baby Pro can collect publishing royalties on artist behalf. Optionally, one can set up their own publishing entity and If you're independent, register as your own publisher to collect the publisher's share of royalties.

Each PRO uses different formulas for payouts. SESAC, being for-profit, often pays more per play but is invite-only. Royalty statements require continuous monitoring and comparing to your personal maintained performance records. Often there are missing payments.

There are royalty tracking tools, services like Royalty Exchange or Jammber to help analyze earnings and detect missing payments. Again middlemen all cost money. The more your songs are played, streamed, or placed in media, the more royalties you earn.

Promoting works, e.g., music through social media, YouTube, and Spotify playlists to increase airplay and inturn royalty. Revenue from streaming has become more complex and fraud has increased.

For example, phone farms are setups where hundreds or thousands of smartphones are used to generate fake engagement by automatically streaming, clicking, or interacting with content. These farms are usually run by bots or cheap labor in countries with low electricity and data costs.

Fraudsters set up fake playlists or videos and use phone farms to stream them repeatedly. Platforms like Spotify and YouTube pay artists/creators based on streams, so scammers inflate numbers to collect fraudulent royalties.

### EXAMPLE

A scammer uploads 1,000 low-effort or AI generated tracks to Spotify.

They set up a phone farm to stream their own music 24/7.

If each stream generates $0.003, a farm with 1,000 phones running 24/7 can make thousands of dollars per month in fake royalties.

Click and Ad Fraud (Google Ads, TikTok, etc.) Phone farms fake ad clicks to make money through PPC (pay-per-click) advertising. Ad farms repeatedly click on ads to drain competitors' budgets or boost revenue for a scammer's website.

### EXAMPLE

A fraudster joins Google AdSense and creates a website full of ads. A phone farm generates millions of fake ad clicks, making it look like real users are engaging. Google pays out ad revenue until the fraud is detected.

Social Media Manipulation (Instagram, Twitter, etc.) Phone farms are used to fake engagement (likes, comments, follows) to boost influencers or scam people. Fake bot accounts can be sold to influencers or political campaigns.

### EXAMPLE

A company wants to inflate its follower count on Instagram.

A phone farm automates fake follows, likes, and comments to make their account look more popular. This can deceive real users and boost sponsorship deals.

Phone farms lead to royalty fraud and advertising payment fraud. Fraudsters steal royalty money that should go to real musicians, YouTubers, and influencers. Platforms may reduce payout rates to compensate for fraud, hurting honest creators.

Advertisers lose money on fake clicks, making them less likely to invest in digital ads. Streaming services waste resources paying for fake engagement, forcing them to crack down on independent artists. Phone farms encourage low-quality spam content because people are only focused on monetization, not quality. Some platforms (Spotify, YouTube) are flooded with AI-generated music/videos designed to farm revenue.

Accordingly this is a major issue and there is a significant need to provide accurate information, and real time royalty payout by diminishing fraud. Platforms like YouTube and Spotify use AI to detect bot-like streaming patterns (e.g., abnormal repeat plays from the same device).

Google Ads monitors click patterns to detect farms. Accounts suspected of using phone farms are permanently banned and their earnings are withheld. Streaming services blacklist IPs linked to fraud rings.

As previously mentioned, the above issues are not isolated to music. Theaters pay movie studios a percentage of ticket sales (usually around 40-60%). Major chains negotiate different splits, with studios taking a larger cut for big releases.

Subscription Streaming (SVOD): Platforms like Netflix, Disney+, and Amazon Prime pay studios a licensing fee to stream the movie. Transactional Video on Demand (TVOD): Digital rentals/purchases on iTunes, Google Play, or Amazon. Ad-Supported Streaming (AVOD): Free platforms like Tubi and YouTube generate ad revenue, which is split between the platform and rights holders.

TV Licensing-Networks (HBO, FX, etc.) pay for exclusive broadcasting rights for a limited time. Syndication deals (reruns on cable networks) bring in long-term royalties. Home Media (DVD, Blu-ray, Digital)—Studios earn money from DVD/Blu-ray sales and digital downloads.

Physical media is declining but still generates revenue in international markets. Merchandising and Product Licensing-Blockbusters (Marvel, Star Wars, etc.) make billions from merchandise sales (toys, clothing, collectibles). Some actors and directors negotiate royalty shares from merchandise sales.

International Distribution-Studios sell regional distribution rights to foreign companies, who then release the movie in specific countries.

Music and Soundtrack Royalties-Movie soundtracks generate royalties for composers, artists, and record labels. Revenue comes from streaming, physical sales, and licensing for commercials or TV shows.

Actors, Writers and Directors Earn Royalties (or residuals) ensuring that key contributors continue earning after the movie's initial release. Actors and Writers (via Guilds)-Unions like SAG-AFTRA (actors) and WGA (writers) negotiate royalty payments.

Residuals kick in when movies are rebroadcasted, streamed, or sold. Older movies (like 90s blockbusters) still generate residuals for their creators.

Some directors or producers negotiate backend deals (a % of total box office or profits). James Cameron, Christopher Nolan, and Spielberg often take backend cuts. Creators of franchises like Star Wars, Marvel, and Harry Potter earn royalties when their characters or stories are used in sequels/spinoffs.

Hollywood Accounting: Studios often claim movies haven't made a profit (even if they have) to avoid paying royalties. Streaming Loopholes: Many streaming platforms pay a flat licensing fee, reducing residual earnings for actors and writers. Contract Disputes: Creators sometimes have to sue studios to get unpaid royalties (e.g., Scarlett Johansson vs. Disney over Black Widow).

The current royalty systems in place are riddled with security problems and delays. Accordingly, the instant invention is aimed at overcoming the issues surrounding royalty payment and reducing fraud in the system.

### SUMMARY OF INVENTION

It is an object to streamline royalty payments for owners of proprietary content data in a realtime manner.

A further object is to reduce fraud in unauthorized use of proprietary data and reduce payments in for unauthorized use of proprietary data.

An aspect of the invention is directed to a system enabling content creators to upload their media, which is then distributed directly to major streaming platforms via integrated APIs. Real-time streaming data is aggregated and processed by smart contracts to calculate and immediately disburse royalty payments using a proprietary token (Royalty Token, RLT). The platform further integrates AI for automated licensing, sample clearance, and detection of unclaimed royalties, and includes features such as NFT monetization and live streaming with real-time tipping. This decentralized solution ensures full transparency, security, and enhanced revenue for content creators, disrupting traditional royalty distribution methods.

Another aspect of the present invention provides a decentralized, blockchain-based platform for real-time royalty distribution that overcomes the limitations of traditional systems. The system allows artists and content creators to:

Register and onboard onto a platform by creating a profile and connecting a cryptocurrency wallet, which can be a platform provided crypto wallet enabling a staking feature.

Upload music, podcasts, or other digital content, where metadata is automatically captured and verified.

Distribute content directly to major streaming platforms through API integrations, for example, with services such as Vydia and FUGA.

Collect real-time streaming data initiated by a real user from sources like Muso.ai and Soundcharts, which is aggregated and recorded on a blockchain.

Calculate royalties instantly using AI-driven algorithms and smart contracts, which then execute real-time payouts using a proprietary token (RLT) to the crypto wallet.

Further, the system can automatically detect unclaimed royalties and perform AI-powered sample clearance by interfacing with licensing databases (ASCAP, BMI, SESAC), ensuring that all revenue splits are handled in a correct percentage of ownership and terms of smart contract.

Provide additional monetization channels such as NFT-based rights sales and live streaming with real-time tipping.

The invention provides a comprehensive solution that not only maximizes artist/owner revenue by bypassing intermediaries but also enhances transparency, efficiency, and legal compliance through automated processes.

Accordingly, one aspect of the invention is directed to a computer-implemented method for implementing real-time royalty and enforcing real-time royalty payments in a blockchain network, the method comprising:
(a) providing a portal platform for rights owner onboarding and registration data and providing a crypto wallet for smart contract credit and debit transactions;
(b) uploading user proprietary content data and metadata corresponding to the proprietary content data through said portal platform;
(c) storing the proprietary content data in a decentralized storage system;
(d) employing an AI module for detecting a transaction use of the proprietary content data and using the smart contract stored on a blockchain, wherein said transaction request is associated with a digital asset;
(e) verifying, via a distributed ledger, a use of the digital asset by a first entity to said rights owner;
(f) automatically computing a royalty payment based on a predefined royalty percentage in connection with the smart contract;
(g) executing a transfer of at least a portion of the transaction value to the rights owner using a cryptographically secure digital transaction; and
(h) recording the completed transaction on the blockchain to create an

immutable ledger entry.

Another aspect of the invention is directed to a decentralized system for real-time royalty distribution for digital content, comprising:
a rights owner onboarding module that verifies identity and connects a crypto wallet;
a content upload module that extracts and validates metadata from proprietary content from the rights owner;
a distribution engine that transmits the proprietary content data to multiple streaming platforms via direct API integrations;
a data aggregation module that collects real-time streaming of the proprietary content data from external sources;
a royalty calculation module that utilizes AI module to compute at least one of royalties and revenue splits; and
a smart contract execution module that instantaneously disburses a proprietary token to a rights owner crypto wallet.

### BRIEF DESCRIPTION OF THE DRAWINGS

FIG. 1 depicts a first part of an embodiment of flowchart of operations of the system.

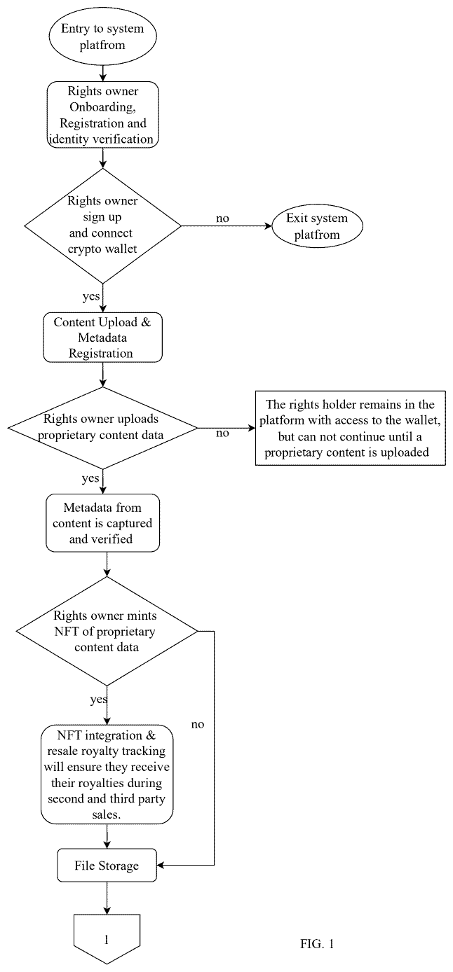

FIG. 2 depicts a second part of an embodiment of flowchart of operations of the system.

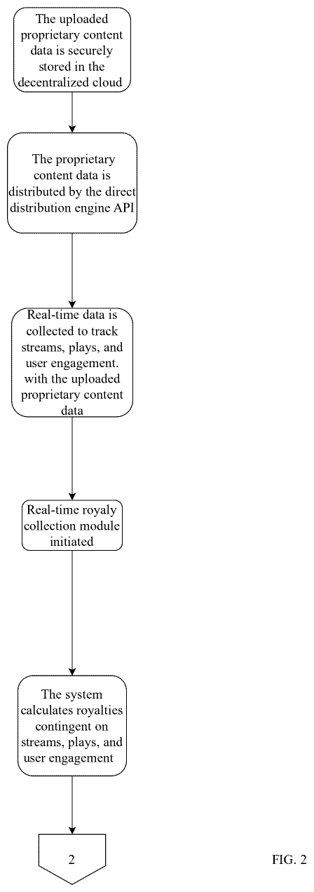

FIG. 3 depicts a third part of an embodiment of flowchart of operations of the system.

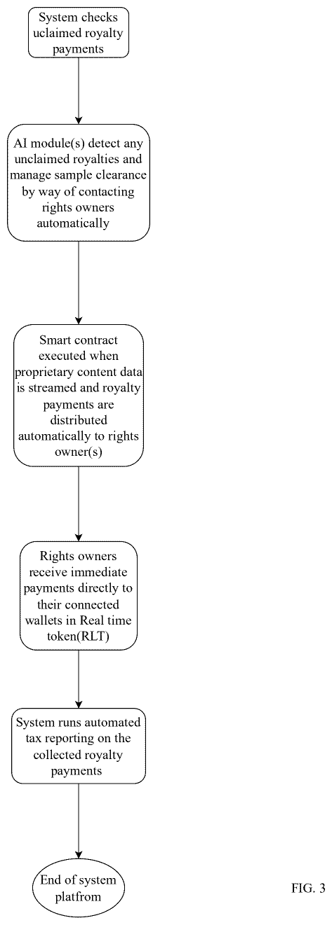

FIG. 4 depicts a diagram of components of an embodiment of the invention.

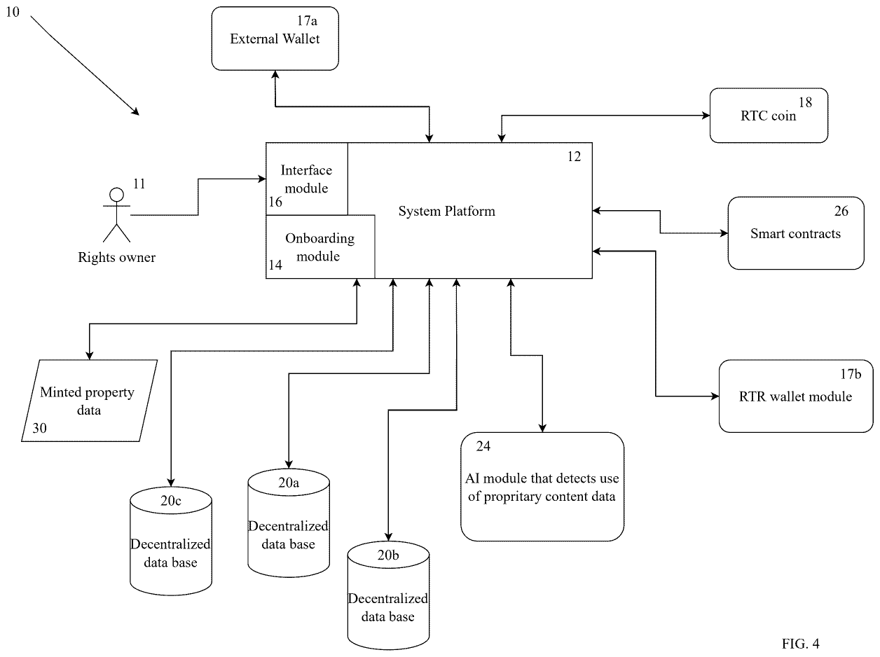

### DETAILED DESCRIPTION OF THE INVENTION

Referring now to the drawings, the system of the invention which provides a decentralized, blockchain-based platform for real-time royalty distribution is generally designated by the numeral 10. The system 10 provides a real time royalty (RTR) distribution platform 12.

The RTR platform 12 includes a rights owner (e.g., artist) 11 onboarding and registration module 14 equipped to receive personal data corresponding to the rights owner 11, such as name, address, email, contact number. An interface module 16 which can be web-based and/or a mobile application is provided to permit the rights owner 11 to register, create profiles, and connect one or more crypto wallet(s) 17a, 17b. An aspect of the invention is to provide payments through exchange of RTR coins 18 generated via the platform 12 and thus the artist can retain the RTR coin or migrate the RTR coin(s) 18 through a conventional exchange to cash them out. Here, however, the rights owner 11 is provided a unique staking aspect where the value of the RTR coin 18 can increase over time, unlike more conventional USD payouts.

Turning back to operation, wherein content upload and metadata registration is enabled. The RTR platform 12 receives rights owner 11 upload of proprietary content data 20, such as music/podcast/video content. The system 10 automatically extracts and registers metadata via APIs 19 explained hereinafter. Metadata in a song can include details like title, artist, album, genre, year, track number, ISRC code, and more. These details can be extracted using embedded Metadata Tags (ID3, Vorbis, APE, etc.) MP3 files use ID3 tags (ID3v1, ID3v2) to store metadata.

FLAC, OGG, and other formats use Vorbis Comments or other tagging systems. Tools like FFmpeg, MediaInfo, ExifTool can extract this metadata programmatically.

Audio Fingerprinting (Music Recognition Technology) is used if metadata is missing, and a software module can analyze the song's waveform and match it against a music database (like AcoustID, Shazam, or Gracenote). APIs like Audd.io, MusicBrainz, or Spotify's Audio Analysis API can retrieve details based on fingerprinting.

AI-Based Audio Analysis can be used wherein advanced tools use AI to recognize patterns, instruments, BPM, key, and mood. Services like Echonest (now part of Spotify) and Essentia provide music feature extraction.

Once extracted, metadata can be stored or registered in Music File Tags 20a. 20B, 20c . . . using tools like Mp3tag, TagScanner, Mutagen (Python library), or Kid3 to write metadata back into the song file.

Metadata can be submitted to databases and music directories such as MusicBrainz (open music database), Discogs (vinyl/CD database), Gracenote (used by iTunes and other platforms), and ISRC Registries (for copyright and royalty tracking).

The system 10 provides an automating process to automate metadata extraction and registration. An exemplary tool includes Python Scripts with Mutagen or Eyed3—To read/write metadata; APIs like MusicBrainz, Last.fm, or ACRCloud—To fetch metadata automatically; Batch processing with FFmpeg or MediaInfo—To extract metadata in bulk.

The system 10 utilizes various storage tools, where data content is stored using a hybrid approach that includes Google Cloud for fast access and decentralized storage solutions like IPFS/Filecoin for integrity. A direct distribution engine module 22 provides integration with APIs 19 such as Vydia and FUGA allows for direct distribution to streaming platforms (e.g., Spotify, Apple Music, Amazon Music, Tidal, etc.). Integration with APIs like Vydia and FUGA for Direct Distribution

APIs from Vydia and FUGA streamline music distribution by enabling automated metadata handling, rights management, and direct delivery to streaming platforms like Spotify, Apple Music, and YouTube Music. When integrating with Vydia or FUGA, the API allows for:
Uploading audio and video files (WAV, FLAC, MP4)
Extracting and embedding metadata (artist, track name, ISRC, UPC, copyright, etc.);
Artwork and lyrics submission;
Assigning release dates and territory restrictions;
These platforms ensure metadata compliance so that all streaming services receive properly formatted data.

Vydia and FUGA handle rights management and monetization, for example, royalty splits in assigning earnings to multiple contributors (artists/owners). Further, these APIs ensuring proper attribution for rights holders; content ID (YouTube, Facebook, Instagram) with automatic tracking and monetization. This ensures artists/owners, labels, and managers get paid correctly when their proprietary content data is used, e.g., music is played or used.

The system 10 provides for automated distribution to DSPs (Digital Streaming Platforms). Once metadata and rights are set, the API allows for direct delivery to streaming services like Spotify, Apple Music, Amazon Music, Tidal, Deezer, etc. and automated release scheduling without manual submission needed.

The system 10 provides for real-time status tracking to check if a release is live or needs updates. Vydia and FUGA act as a backend bridge, ensuring files reach platforms without manual input.

After distribution, the API enables:
Streaming and revenue insights—Plays, downloads, listener demographics
Playlist tracking—See if a track lands on curated playlists
Royalty reports—Breakdowns of earnings per platform, per region

Labels and artists can optimize marketing strategies based on real-time data. These APIs provide time-savings over direct uploads. The APIs are scalable and manage multiple artists and releases efficiently. The APIs enable proper tracking wherein payments can be made realtime to the artist/owner. Access to premium DSP features. Some platforms (like Apple and Spotify) provide extra tools to verified distributors

The RTR platform 12 collects streaming data in real time from providers such as Muso.ai and Soundcharts. A Royalty calculation is triggered by module 24 upon detecting use of proprietary content data 20 and using smart contract 26 and where an AI-driven algorithm(s) computes total royalty owed based on streaming data and predetermined revenue splits.

### Smart Contract Execution and Instant Payment:

Smart contracts deployed on a blockchain (initially Ethereum) process the royalty calculations and trigger instant payouts in Royalty Token (RLT) to artists'/owners' wallets, e.g., their RTR wallet. Each smart contract is a self-executing program stored on a blockchain that automatically enforces the terms of an agreement without the need for intermediaries. It runs on if-then conditions, meaning once certain conditions are met, the contract executes predefined actions.

Two or more parties agree on contract terms. In the instant case, the artist/owner of proprietary content data (digital asset) provides the terms on the platform, which is a real-time royalty platform, upon onboarding and signing up on the platform 12. Once uploading the proprietary content data, such as a song, or video, this data is placed into a decentralized storage for reducing fraudulent use.

Conditions and Rules are written into the contract as code (e.g., “If there is detected a request for access and use of the proprietary content data, for example, a stream for a minimum predetermined period ΔT, e.g., 3 or more seconds, smart contract 26 is initiated and payment is initiated to the owner by way of an agreed amount of crypto currency (real time token) RLT in the right owner's digital wallet 17a or 17b.

The contract is deployed on a blockchain (Ethereum, Solana, etc.), making it immutable and tamper-proof. Execution and Automation—Once the conditions are met, the contract executes automatically without third-party intervention. Transparency and security are maintained in transactions which are visible to all network participants and cannot be altered once deployed.

The contract is created when written in a blockchain-compatible language (e.g., Solidity for Ethereum). It is deployed when uploaded to a blockchain network. The triggering event can include external inputs (like user actions) which activate the contract. Once the contract verifies conditions, it executes and carries out predefined actions (e.g., releasing funds). Every action is recorded permanently on the blockchain, ensuring security and transparency.

NFTs and digital ownership ensures artists get royalties from resales (e.g., OpenSea, Rarible). NFTs (Non-Fungible Tokens) and digital ownership ensure artists receive royalties from resales through smart contracts on blockchain platforms like OpenSea and Rarible. Here's how it works:

### 1. Smart Contracts Automate Royalties

When an artist mints an NFT, they can set a royalty percentage (e.g., 10%) in the smart contract.

Every time the NFT is resold, the contract automatically ensures the artist gets a percentage of the resale price.

### AI-Powered Licensing and Unclaimed Royalties Recovery:

An integrated AI agent monitors for sample clearance, automatically obtains necessary licenses (synchronization, mechanical, public performance, etc.) via interfaced licensing APIs, and identifies unclaimed royalties for distribution.

### NFT Integration and Live Streaming:

Additional modules allow artists to mint NFTs of their content and engage in live streaming with real-time tipping.

### Analytics and Reporting Dashboard:

Both artists and administrators have access to a comprehensive dashboard for real-time analytics, transaction history, and automated tax reporting (e.g., 1099 forms).

### Key Code Components:

### Royalty Token Smart Contract (RLT):

Smart Contract for Royalty Payments (Solidity—Ethereum)
This ERC-20-based smart contract ensures instant royalty payouts when an API registers a song play.

```
solidity
// SPDX-License-Identifier: MIT
pragma solidity \hat{ }0.8.19;
contract RoyaltyToken {
  string public name = ″Royalty Token″;
  string public symbol = ″RLT″;
  uint8 public decimals = 18;
  uint256 public totalSupply;
  mapping(address => uint256) public balanceOf;
  mapping(address => mapping(address => uint256)) public allowance;
  event Transfer(address indexed from, address indexed to, uint256 value);
  event Approval(address indexed owner, address indexed spender, uint256 value);
  constructor(uint256 _initialSupply) {
    totalSupply = _initialSupply * 10**uint256(decimals);
    balanceOf[msg.sender] = totalSupply;
  }
  function transfer(address_to, uint256 _value) public returns (bool success) {
    require(balanceOf[msg.sender] >= _value, ″Insufficient balance″);
    balanceOf[msg.sender] −= _value;
    balanceOf[_to] += _value;
    emit Transfer(msg.sender, _to, _value);
    return true;
  }
  function approve(address _spender, uint256 _value) public returns (bool success) {
    allowance[msg.sender][_spender] = _value;
    emit Approval(msg.sender, _spender, _value);
    return true;
  }
  function transferFrom(address _from, address _to, uint256 _value) public returns
(bool success) {
    require(balanceOf[_from] >= _value, ″Insufficient balance″);
    require(allowance[_from][msg.sender] >= _value, ″Allowance exceeded″);
    balanceOf[_from] −= _value;
    balanceOf[_to] += _value;
    allowance[_from][msg.sender] −= _value;
    emit Transfer(_from, _to, _value);
    return true;
  }
}
```

This contract mints Royalty Tokens (RLT) and enables transfers.

Can integrate with real-time streaming APIs to auto-pay artists.

Use Oracle APIs (Chainlink) for accurate royalty calculations implements ERC20 functionality.[insert Code]

Mints an initial supply and provides methods for token transfers.[insert Code]

### Royalty Payout Smart Contract:

An example, AI-Powered Royalty Search & Distribution (Python—AI Model)

This script scans Muso.ai & Soundcharts APIs for missing royalties and auto-pays artists.

```
  python
  CopyEdit
  import requests
  import json
  from web3 import Web3
  # Connect to Ethereum Network
  infura_url = ″https://mainnet.infura.io/v3/YOUR_INFURA_
  PROJECT_ID″
  web3 = Web3(Web3.HTTPProvider(infura_url))
  # Royalty Token Smart Contract
  contract_address =
″0x2a80b7B7aE55b204bb767b1b10588275F1B182F4″
  abi = json.loads(′[YOUR_SMART_CONTRACT_ABI]′)
  contract = web3.eth.contract(address=contract_address, abi=abi)
  # API Keys
  MUSO_AI_API = ″YOUR_MUSO_AI_API_KEY″
  SOUNDCHARTS_API = ″YOUR_SOUNDCHARTS_API_KEY″
  # Get artist royalties from Muso.ai
  def get_royalties(artist_id):
    headers = {″Authorization″: f″Bearer {MUSO_AI_API}″}
    response = requests.get(f″https://api.muso.ai/royalties/{artist_id}″,
headers=headers)
    return response.json( )
  # Process and distribute royalties
  def distribute_royalties(artist_wallet, amount):
    sender_wallet = ″YOUR_WALLET_ADDRESS″ (a person
skilled in the art will understand what this function is for coding
purposes)
    private_key = ″YOUR_PRIVATE_KEY″ (a person skilled
in the art will understand what this function is for coding purposes)
    nonce = web3.eth.get_transaction_count(sender_wallet)
    txn = contract.functions.transfer(artist_wallet,
amount).build_transaction({
      ″from″: sender_wallet,
      ″gas″: 2000000,
      ″gasPrice″: web3.to_wei(″50″, ″gwei″),
      ″nonce″: nonce,
    })
    signed_txn = web3.eth.account.sign_transaction(txn, private_key)
    txn_hash = web3.eth.send_raw_transaction(signed_
    txn.rawTransaction)
    return f″Transaction Hash: {web3.to_hex(txn_hash)}″
  # Fetch and Pay Artists
  def pay_all_artists( ):
    artists = get_royalties(″RTR_ARTISTS_LIST″) (a person skilled
in the art will understand what this function is for coding purposes)
    for artist in artists:
      distribute_royalties(artist[″wallet″], artist[″royalty_amount″])
  pay_all_artists( )
```

This operates by connecting to Muso.ai and Soundcharts for real-time royalty tracking.

Uses Web3.py to send automatic payouts.

Runs on a scheduled loop to check for unpaid royalties daily.

Royalty Data Tracking Algorithms (Node.js-Royalty API)

This backend system tracks music plays & royalties from all connected sources.

```
  javascript
  const express = require(″express″);
  const axios = require(″axios″);
  const Web3 = require(″web3″);
  const app = express( );
  const port = 3000;
  // Ethereum Web3 Connection
  const web3 = new
Web3(″https://mainnet.infura.io/v3/YOUR_INFURA_PROJECT_ID″);
(a person skilled in the art will understand what this function is for coding
purposes)
  // Royalty Smart Contract
  const contractABI = [YOUR_SMART_CONTRACT_ABI]; (a person
skilled in the art will understand what this function is for coding purposes)
  const contractAddress =
″0x2a80b7B7aE55b204bb767b1b10588275F1B182F4″;
  const contract = new web3.eth.Contract(contractABI, contractAddress);
  // API Keys
  const MUSO_AI_API = ″YOUR_MUSO_AI_API_KEY″; (a person
skilled in the art will understand what this function is for coding purposes)
  const SOUNDCHARTS_API = ″YOUR_SOUNDCHARTS_API_
KEY″; (a person skilled in the art will understand what this function is
for coding purposes)
  // Fetch royalty data
  app.get(″/track-royalties″, async (req, res) => {
  try {
      const musoData = await axios.get(″https://api.muso.ai/
      royalties″, {
        headers: { Authorization: ′Bearer ${MUSO_AI_API}′ },
      });
      const soundchartsData = await
axios.get(″https://api.soundcharts.com/royalties″, {
        headers: { Authorization: ′Bearer ${SOUNDCHARTS_API}′ },
      });
      const royaltyData = [ ...musoData.data, ...soundchartsData.data];
      res.json({ success: true, data: royaltyData });
    } catch (error) {
      res.json({ success: false, error: error.message });
    }
  });
  // Pay artists instantly
  app.post(″/pay-royalties″, async (req, res) => {
    const { artistWallet, amount } = req.body;
    const senderWallet = ″YOUR_WALLET_ADDRESS″;(a person
skilled in the art will understand what this function is for coding
purposes)
    const privateKey = ″YOUR_PRIVATE_KEY″;(a person
skilled in the art will understand what this function is for coding
purposes)
    const txn = contract.methods.transfer(artistWallet,
amount).encodeABI( );
    const signedTxn = await web3.eth.accounts.signTransaction(
      {
        to: contractAddress,
        data: txn,
        gas: 2000000,
        gasPrice: web3.utils.toWei(″50″, ″gwei″),
      },
      privateKey
    );
    const txnReceipt = await
web3.eth.sendSignedTransaction(signedTxn.rawTransaction);
    res.json({ success: true, transactionHash: txnReceipt.transactionHash
});
  });
  app.listen(port, ( ) => console.log( Royalty Tracker API running on port
${port}′));
```

Pulls real-time data from Muso.ai & Soundcharts.

Sends automatic payments to artist wallets via smart contracts.

### Can be Scaled for Millions of Artists

Calculates and processes payouts using smart contracts.[insert Code]

Interacts with a dedicated wallet (e.g., via Gnosis Safe) for added security. (a person skilled in the art will understand what this function is for coding purposes)

### AI-Powered Unclaimed Royalties Distributor Contract:

(a person skilled in the art will understand what this function is for coding purposes)

Registers and processes unclaimed royalties. (a person skilled in the art will understand what this function is for coding purposes)

Uses an AI confidence score to determine whether automatic payouts can be executed. (a person skilled in the art will understand what this function is for coding purposes)

### Backend API Endpoints (NestJS/Node.js):

Provides RESTful endpoints for content uploads, royalty data retrieval, and integration with streaming data providers.

Connects to cloud storage for file uploads and communicates with smart contracts via Web3.js.

### Frontend Applications (Next.js & React Native):

Next.js website with pages for artist onboarding, dashboard, uploads, and analytics.

React Native mobile app for cross-platform access, including wallet integration and live streaming. (a person skilled in the art will understand what this function is for coding purposes)

It is worth mentioning other platforms. For example, OpenSea, Rarible, Foundation, and SuperRare support automated royalties. When resale occurs on-chain, the smart contract executes the royalty payment instantly. Sellers don't have to manually send payments to artists, everything is handled automatically.

On-Chain Vs. Off-Chain Royalties

On-chain royalties: Embedded directly in the smart contract, ensuring enforcement across all blockchain transactions.

Off-chain royalties: Some marketplaces may not enforce royalties if they process transactions off-chain (e.g., Blur, LooksRare offer optional royalties).

### Challenges and Workarounds

Some platforms have started allowing zero-royalty transactions, where

buyers can bypass paying royalties.

To combat this, some projects use “royalty-protected” contracts, ensuring sales only happen on royalty-enforcing platforms.

Artists can also issue token-gated access (e.g., perks, future airdrops) to incentivize users to buy from royalty-friendly platforms.

### How Major NFT Marketplaces Handle Royalties

Each NFT platform has its own approach to enforcing or bypassing royalties:

### OpenSea

Default Royalty Model: Enforces creator royalties via smart contracts.

Optional Royalties: In late 2023, OpenSea introduced an optional royalty model, meaning buyers can choose whether to pay royalties.

Operator Filter: Used to block zero-royalty marketplaces, but later removed, giving traders more flexibility.

Rarible remains one of the few platforms committed to enforcing creator royalties.

Supports Multi-Chain NFTs: Works on Ethereum, Tezos, Polygon, and Solana.

### Blur

Low/Zero Royalties: Primarily trader-focused, it allows users to set royalties to 0%.

Competitive With OpenSea: Offers low fees to attract high-volume traders.

### LooksRare

Optional Royalties: Allows buyers to pay royalties voluntarily.

Revenue Share Model: A portion of marketplace fees is distributed to artists.

### Foundation and SuperRare

Strong Royalty Enforcement: These platforms cater to high-end art collections and enforce creator royalties.

### Strategies for Artists to Ensure Royalties

Since some marketplaces allow zero-royalty transactions, artists can use different strategies to protect their earnings.

### The Future of Movie Royalties

AI and Digital Actors: New contracts will likely include royalties for AI-generated performances. Phone farm fraud could also be addressed with tougher regulations where governments might crack down on ad fraud and streaming fraud.

An advantage of the system 10 is that it eliminates middlemen, reduces fraud and costs by removing banks, lawyers, and brokers and provides a staking component. The system is fast and automated with no waiting period for approvals; and execution happens instantly. The system 10 is tamper-proof and secure, runs on blockchain, making it nearly impossible to hack.

Transparent and Trustless—Participants don't need to trust each other; the contract enforces the rules.

An exemplary contract allows a buyer to deposit funds, and the seller can withdraw only when the buyer confirms delivery. Example code:

```
  // SPDX-License-Identifier: MIT
  pragma solidity \hat{ }0.8.0;
  contract Escrow {
    address public buyer;
    address payable public seller;
    uint256 public amount;
    bool public isFundsReleased;
    constructor(address _seller) payable {
      buyer = msg.sender; // The buyer deploys the contract
      seller = payable(_seller);
      amount = msg.value; // Buyer sends ETH when creating contract
      isFundsReleased = false;
    }
    // Buyer confirms the transaction, releasing funds to the seller
    function releaseFunds( ) public {
      require(msg.sender == buyer, ″Only the buyer can release funds.″);
      require(!isFundsReleased, ″Funds already released.″);
      require(address(this).balance >= amount, ″Insufficient contract
balance.″);
      isFundsReleased = true;
      seller.transfer(amount); // Send ETH to the seller
    }
    // If there's an issue, buyer can get a refund
    function refundBuyer( ) public {
      require(msg.sender == buyer, ″Only the buyer can refund.″);
      require(!isFundsReleased, ″Funds already released.″);
      payable(buyer).transfer(amount);
    }
    // Get contract balance
    function getBalance( ) public view returns (uint256) {
      return address(this).balance;
    }
  }
```

How this Smart Contract Works

Deployment—The buyer deploys the contract, sending ETH to lock in the payment.

Funds Held in Contract—The smart contract holds the funds securely.

### Release or Refund

The buyer calls releaseFunds( ), and the payment is sent to the seller.

If there's a dispute, the buyer can call refundBuyer( ) to get their money back.

### Security Checks

Only the buyer can trigger payments or refunds.

Funds can be released only once to prevent double-spending.

IPFS (InterPlanetary File System) is a decentralized, peer-to-peer file storage system that allows users to store and share data without relying on a central server. Unlike traditional cloud storage (e.g., Google Drive, AWS), IPFS distributes files across a network, making it more secure, efficient, and censorship-resistant.

### How IPFS Works

### Content-Based Addressing (CID)

In traditional storage, files are accessed by location (e.g., a URL).

IPFS identifies files by their content using a unique cryptographic hash called a CID (Content Identifier).

This means that if the file changes, its CID changes too, ensuring data integrity.

### File Distribution Using Peer-to-Peer (P2P) Network

When a file is uploaded, IPFS splits it into smaller chunks and distributes them across different nodes (computers) in the network.

Nodes store and share the file, making it available even if the original uploader goes offline.

### Retrieving Data

When a user requests a file, IPFS looks up its CID and finds the nearest node that has the data.

The system fetches chunks from multiple nodes, speeding up download times.

### Key Features of IPFS

Decentralized and Censorship-Resistant—No central authority controls the data.

Faster Access—Fetches files from the nearest available nodes instead of a single server.

Tamper-Proof—Since data is hashed, any modification results in a new CID, preventing manipulation.

Efficient Storage—Duplicate files are eliminated across the network, saving space.

### EXAMPLE: USING IPFS FOR NFTS

NFT metadata and images are often stored on IPFS instead of centralized servers. This ensures that NFT artwork remains accessible even if a website shuts down.

The NFT file is uploaded to IPFS.

IPFS generates a CID (e.g., QmX9vB . . . ).

The NFT smart contract stores the CID instead of the actual file.

When users view the NFT, their browser fetches the image from IPFS instead of a centralized server.

IPFS Vs. Traditional Cloud Storage
Feature IPFS Traditional Cloud (AWS, Google Drive)
Centralization Decentralized Centralized
Speed Faster (P2P fetching) Slower (single server)
Security Tamper-proof (CID) Prone to hacking
Availability Always online (distributed) Can go offline
Censorship Resistant Can be taken down

### How to Use IPFS

Install IPFS—Download and install an IPFS node.

Add a File—Use the command line (ipfs add filename) or a web tool (like Pinata or Filebase).

Get the CID—IPFS generates a unique hash (CID) for the file.

Access the File—Open https://ipfs.io/ipfs/[CID] in a browser or use an IPFS gateway.

Musiio is an AI-powered music technology company that specializes in automated music tagging, search, and curation. It helps music labels, streaming services, and other companies analyze large music catalogs efficiently.

AI Music Tagging uses machine learning to analyze audio files and automatically assign metadata (e.g., genre, mood, tempo, energy level). Helps music platforms organize and recommend songs more effectively.

AI-Powered Music Search enables fast and accurate song searches based on audio characteristics rather than just keywords. Useful for sync licensing, playlist curation, and discovering similar tracks. Automated Curation and A and R (Artist and Repertoire) Tools identify trending or high-potential songs for music labels and producers. A and R teams find new talent without manual listening. Music streaming services (e.g., Spotify-like platforms) to enhance search and recommendations. Record labels and A and R teams to scout new artists based on song patterns. Sync licensing companies to match songs with movies, ads, and TV shows.

While the preferred embodiment has been set forth above, there are modifications, derivations and improvements which are believed to be within the appended the claims are accordingly entitled to protection within the scope of the claims.

1. A computer-implemented method for implementing real-time royalty and enforcing real-time royalty payments in a blockchain network, the method comprising:
(a) providing a portal platform for rights owner onboarding and registration data and providing a crypto wallet for smart contract credit and debit transactions;
(b) uploading user proprietary content data and metadata corresponding to said proprietary content data through said portal platform;
(c) storing said proprietary content data in a decentralized storage system;
(d) employing an AI module for detecting a transaction use of said proprietary content data and using a smart contract stored on a blockchain, wherein said transaction request is associated with a digital asset;
(e) verifying, via a distributed ledger, a use of the digital asset by a first entity to said rights owner;
(f) automatically computing a royalty payment based on a predefined royalty percentage in connection with said smart contract;
(g) executing a transfer of at least a portion of the transaction value to said rights owner using a cryptographically secure digital transaction; and
(h) recording the completed transaction on the blockchain to create an immutable ledger entry.

2. The computer-implemented method for implementing real-time royalty and enforcing real-time royalty payments in a blockchain network of claim 1, wherein royalty payments are automatically calculated and distributed in a proprietary token (RLT) upon verification of streaming data for a predetermined period of time.

3. The computer-implemented method for implementing real-time royalty and enforcing real-time royalty payments in a blockchain network of claim 1, wherein an AI agent automatically identifies sampled content of said proprietary content data.

4. The computer-implemented method for implementing real-time royalty and enforcing real-time royalty payments in a blockchain network of claim 1, wherein an AI agent automatically obtains necessary licenses for said proprietary content data.

5. The computer-implemented method for implementing real-time royalty and enforcing real-time royalty payments in a blockchain network of claim 1, wherein an AI agent automatically detects unclaimed royalties for use of said proprietary content data for distribution.

6. The computer-implemented method for implementing real-time royalty and enforcing real-time royalty payments in a blockchain network of claim 1, wherein said platform provides real-time analytics.

7. The computer-implemented method for implementing real-time royalty and enforcing real-time royalty payments in a blockchain network of claim 1, wherein said platform provides real-time transaction histories.

8. The computer-implemented method for implementing real-time royalty and enforcing real-time royalty payments in a blockchain network of claim 1, wherein said platform provides real-time automated tax reporting.

9. The computer-implemented method for implementing real-time royalty and enforcing real-time royalty payments in a blockchain network of claim 1, which includes an NFT integration module for monetizing digital content, wherein music rights can be tokenized and used or sold, generating additional royalty streams.

10. The computer-implemented method for implementing real-time royalty and enforcing real-time royalty payments in a blockchain network of claim 1, wherein smart contracts automatically allocate payments among multiple parties (artists, rights holders, producers) based on predefined percentages.

11. The computer-implemented method for implementing real-time royalty and enforcing real-time royalty payments in a blockchain network of claim 1, wherein said smart contract automatically allocates payments among multiple parties based on predefined percentages.

12. The computer-implemented method for implementing real-time royalty and enforcing real-time royalty payments in a blockchain network of claim 1, wherein said crypto wallet enables staking.

13. The computer-implemented method for implementing real-time royalty and enforcing real-time royalty payments in a blockchain network of claim 1, wherein said crypto wallet enables exchange into a second currency.

14. A decentralized system for real-time royalty distribution for digital content, comprising:
a rights owner onboarding module that verifies identity and connects a right owner crypto wallet;
a content upload module that extracts and validates metadata from proprietary content through the rights owner onboarding module;
a distribution engine that transmits said proprietary content data to multiple streaming platforms employing direct API integrations;
a data aggregation module that utilizes AI module to collect real-time streaming of said proprietary content data from external sources;
a royalty calculation module that utilizes AI module to compute at least one of royalties and revenue splits; and
a smart contract execution module that instantaneously disburses a proprietary token to the rights owner crypto wallet.

15. The decentralized system for real-time royalty distribution of claim 14, which includes an AI-powered licensing module that automates the acquisition of necessary licenses for sample clearance.

16. The decentralized system for real-time royalty distribution of claim 14, which includes a reporting dashboard module that provides at least one of real-time analytics and automated tax reporting.

17. The decentralized system for real-time royalty distribution of claim 14, wherein said smart contract execution module records all transactions on an immutable blockchain ledger to ensure transparency and auditability.

18. The decentralized system for real-time royalty distribution of claim 14, which includes a module for NFT minting that tokenizes said proprietary content data enabling secondary royalty revenue.

19. The decentralized system for real-time royalty distribution of claim 14, wherein said onboarding module includes one of integration of connection to a crypto wallet and creation of a real time royalty wallet through said system enable direct receipt of royalty payments.

20. The decentralized system for real-time royalty distribution of claim 15, wherein the AI-powered licensing module automatically identifies unclaimed royalties and triggers the distribution of said royalties via smart contracts.

21. The decentralized system for real-time royalty distribution of claim 14, wherein said distribution engine integrates with external APIs from automated metadata handling, rights management, and direct delivery to streaming platforms to deliver content to major streaming platforms without the use of traditional aggregators.

22. The decentralized system for real-time royalty distribution of claim 14, wherein said royalty calculation module utilizes real-time streaming data collected from an API Module handling rights management and monetization including one of royalty splits in assigning earnings to multiple rights owners in order to compute royalty payments based on a predefined rate per stream.

23. The decentralized system for real-time royalty distribution of claim 22, which creates smart contracts automatically allocating royalty payment data among multiple parties based on predetermined percentage data.

24. The decentralized system for real-time royalty distribution of claim 14, wherein said system is integrated into a multi-platform environment comprising a web application and a mobile application for universal access.

25. The decentralized system for real-time royalty distribution of claim 14, wherein said royalty calculation module royalty payments are automatically calculated and distributed using a proprietary token (RLT) upon verification of streaming data for a predetermined period of time.

26. A decentralized system for real-time royalty distribution for digital content, comprising:
a rights owner onboarding module that verifies identity and connects a right owner crypto wallet;
a content upload module that extracts and validates metadata from proprietary content through the rights owner onboarding module;
a distribution engine that transmits said proprietary content data to multiple streaming platforms employing direct an API integration module;
a data aggregation module to collect real-time streaming of said proprietary content data from external sources;
a royalty calculation module to compute at least one of royalties and revenue splits; and
a smart contract execution module that instantaneously disburses a proprietary token to the rights owner crypto wallet.

27. The decentralized system for real-time royalty distribution of claim of 26, wherein said data aggregation module employs an AI module.

28. The decentralized system for real-time royalty distribution of claim of 26, wherein said royalty calculation module employs an AI module.
